(19) United States
(12) Patent Application Publication
(10) Pub. No.: US 2011/0289548 A1
(43) Pub. Date: Nov. 24, 2011

(54) Guard Computer and a System for Connecting an External Device to a Physical Computer Network

(76) Inventors: Georg Heidenreich, Erlangen (DE); Wolfgang Leetz, Uttenreuth (DE)

(21) Appl. No.: 13/110,397

(22) Filed: May 18, 2011

Related U.S. Application Data
(60) Provisional application No. 61/345,728, filed on May 18, 2010.

(51) Int. Cl. G06F 17/00

(52) U.S. Cl. 726/1; 726/11; 726/12

(57) ABSTRACT

A guard computer and a system including the guard computer for connecting an external device to a physical computer network are provided. The guard computer includes a network interface for connecting to the physical computer network, a device interface for connecting the external device having a data repository containing data, The guard computer also includes a configuration file containing a set of rules for making the data available to the network and a processor making data available to the network based upon the set of rules.

### CROSS REFERENCE TO RELATED APPLICATIONS

The present application claims the benefit of a provisional patent application filed on May 18, 2010, and assigned application No. 61/345,728, which is incorporated by reference herein in its entirety.

### FIELD OF THE INVENTION

The present invention relates to a guard computer and a system for connecting an external device to the physical computer network.

### BACKGROUND OF THE INVENTION

Computer networks are a collection of computers and devices connected by communication channels that facilitate communication among users and allow users to share resources with other users. Computer network can be a large network such as a wide area network (WAN) or Internet, or a small network such as a local area network (LAN) or a physical computer network in an organization such as a hospital, a factory or a small business unit.

A physical network includes computers and other peripheral devices connected to each other, and also allow an external device which is not the part of the physical computer network to be connected to the physical computer network. The external device may be a portable computer, an external storage device such as a memory card, a universal serial bus (USB) drive, etc. The external devices access data or transfer data to the physical computer network. This data includes information that is relevant for the physical computer network, such as, for example information about a patient admitted to a hospital. This information about the patient may then be accessed by the doctors who connect their personal computers to the network.

However, in one example, the external devices which are connected to the physical computer network may contain data which is malicious. In another example, an unauthorized external device may also be connected to the physical computer network and may assist an intruder to steal or destroy useful information from the network. This may cause damage to the physical computer network. For an external device, in the form of a portable computer, anti-virus software is installed in the portable computer to check for malicious data and protecting the data.

Furthermore, external devices which are not the part of physical computer network such as guest computers are not maintained or controlled by the network or its administrator. These computers are needed to be modified to connect to the physical computer network. This is not practical because one should be able to flexibly connect to the physical computer network.

It is therefore desirable to provide a connection for the external device to the physical computer network and also control data being provided to the physical computer network.

### SUMMARY OF THE INVENTION

Briefly in accordance with aspect of the present invention, a guard computer for connecting an external device to a physical computer network is presented. The guard computer includes a network interface for connecting to the physical computer network, a device interface for connecting the external device having a data repository containing data. Further, the guard computer includes a configuration file containing a set of rules for making the data available to the physical computer network and a processor for making data available to the network based upon the set of rules.

In accordance with another aspect of the present invention, a guard computer for connecting an external computer to a physical computer network is presented. The guard computer includes a network interface for connecting to the physical computer network, a device interface for connecting the external computer having a data repository containing data. Further, the guard computer includes a configuration file containing a set of rules for making the data available to the physical computer network and a processor for making data available to the network based upon the set of rules.

In accordance with yet another aspect of the present invention, a system is presented. The system includes a controller computer and a guard computer connected to the controller computer. The guard computer includes a network interface for connecting to the physical computer network, a device interface for connecting the external device having a data repository containing data. Further, the guard computer includes a configuration file containing a set of rules for making the data available to the physical computer network and a processor for making data available to the network based upon the set of rules.

### BRIEF DESCRIPTION OF THE DRAWINGS

The present invention is further described hereinafter with reference to illustrated embodiments shown in the accompanying drawings, in which:

FIG. 1 shows a schematic diagram of a guard computer;

FIG. 2 shows a schematic diagram of a system including the guard computer of FIG. 1; and

FIG. 3 shows a controller computer with a master computer and a proxy computer.

### DETAILED DESCRIPTION OF THE INVENTION

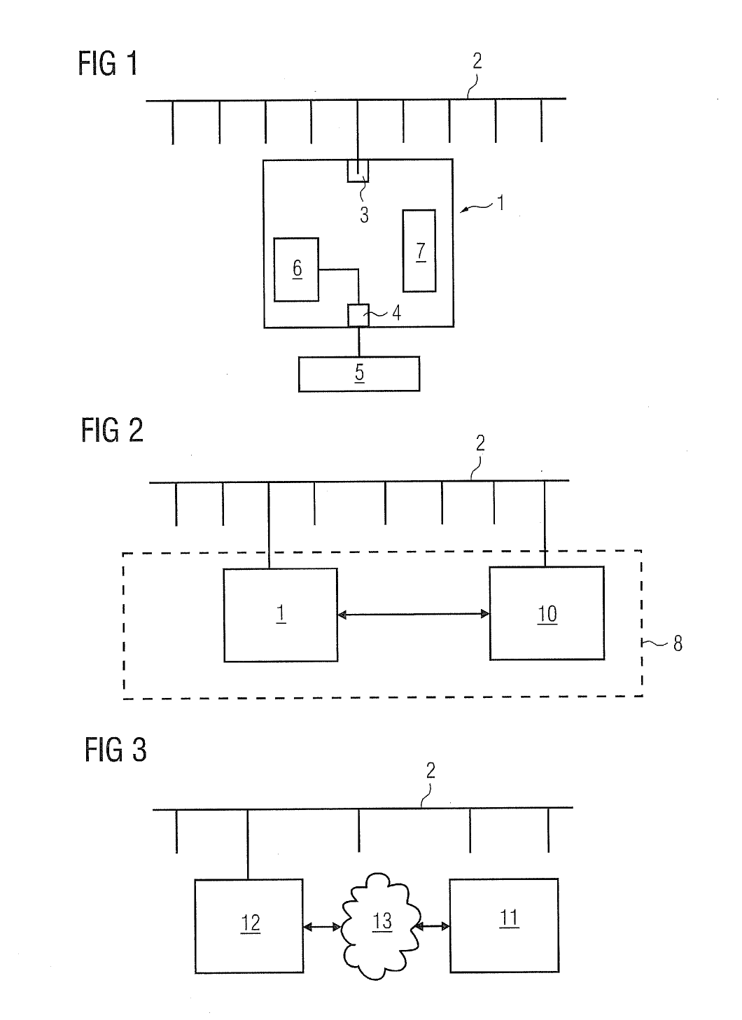

FIG. 1 discloses schematically a guard computer 1 for connecting an external device 5 to a physical computer network 2. As used herein, the physical computer network 2 may include a local area network (LAN). More particularly, the physical computer network 2 may include any such computer network in which the devices are physically connected to each other. These devices may include a workstation, input devices, output devices and the like. As an example, the physical computer network 2 may be a network in a hospital, a factory, or an organization. The guard computer 1 as depicted includes at least two interfaces or adapters, namely, a network interface 3 for connecting the guard computer 1 to the physical computer network 2 and a device interface 4 for connecting an external device 5 to the guard computer 1.

The external device 5 includes a data repository for containing data. The external device 5 may be a data storage device, such as, but not limited to a memory card that can be inserted into a compatible device, a universal serial bus drive, a zip drive and a flash drive. The external device 5 may also be a plug and play device that can be connected to the guard computer 1 without the need of additional drivers. Such an arrangement enables data transfer from the data storage device without the use of any additional components in the device itself thus providing a cost effective solution of transferring data to the physical computer network 2.

Additionally, the external device 5 may be an external computer, such as, but not limited to a portable computer or a desktop computer which includes a data repository, such as, a hard disk, a floppy disk and a compact disk. Such an arrangement advantageously allows portability wherein data can easily be transferred to the guard computer 1 without the guard computer 1 accessing the data itself.

In one example, data from a computer may be loaded into the external device 5, which is typically a memory card or USB drive, this external device 5 can be connected to the guard computer 1. The guard computer 1 examines the data in the external device 5. Thereafter, this data is sent to the physical computer network 2 via the guard computer 1.

The guard computer 1 includes a processor 6 connected to the device interface 4. The processor 6 is configured to access the data from the data repository of the external device 5. As used herein, the term ‘data’ is used to refer to information which may or may not be used by a computer program. In one example, data is infoiination that can be processed by a computer program and may also include files, scripts, an executable computer program and so forth. The guard computer 1 also includes a configuration file 7 that includes a set of rules to be applied on data accessed from the external device 5 before making the data available to the physical computer network 2.

As used herein, the term “configuration file” is a file that can store data, such as the set of rules. The configuration file may include a text file, an extended markup language (XML) file or a database that can store data, such as the set of rules. In the presently contemplated configuration, the configuration file 7 may be stored in a data storage device of the guard computer 1 or in temporary storage such as RAM of the guard computer 1. Alternatively, the configuration file 7 may be a group of components in the guard computer 1 configured to apply a set of rules. The processor 6 is configured to access data from the external device 5 and make the data available to the physical computer network 2 based on the set of rules in the configuration file 7.

As previously noted, the external device 5 can be an external computer for connecting to the physical computer network 2. In this configuration, the external device 5 such as the external computer has a data repository containing data and also has a capability to transmit the data to the physical computer network 2.

In this embodiment, the processor 6 in the guard computer 1 is configured to access the data in the data repository of the external device 5 to check for compliance of the data based upon the set of rules. Such an arrangement enables a cost effective solution wherein data can be easily accessed from the data storage device. Alternatively, the processor 6 is further configured to check the data transmitted from the external device 5 to the guard computer 1 for compliance based upon the set of rules before making the data available to the physical computer network 2. This capability of the processor 6 enables the guard computer 1 to proactively check for the compliance of data in the external device 5, and if the data is not found to be in compliance based upon the set of rules the guard computer can block transmission of data to the physical computer network 2.

By having a dedicated guard computer 1 as a mediator for providing data from the external device 5 to the physical computer network 2 based on the set of rules stored in the guard computer 1, compliance of the data can easily be ensured before entering the physical computer network 2 without having to modify the external device itself.

As used herein, the term “rules” is a prescribed guide for performing an operation and obtaining a certain result. In addition, the term “rules” also implies a set of instructions according to which a system should operate. As an example, rules may specify the type of data, the supported file formats, and the kind of external device that is compatible with the guard computer 1 so that it may be attached to the guard computer 1.

It may be noted that the guard computer 1 is a small computer that includes software and hardware components. The guard computer 1 is configured for connecting an external device 5 to the physical computer network 2 and is additionally configured to perform tasks based on the set of rules which may include tasks such as virus scanning, checking for data integrity, buffering of data, delaying data transfer due to bandwidth limitation, suppressing communication data as required from a local security policy and so forth.

The set of rules in the configuration file 7 specify malicious data. As used herein, the term “malicious data” may include a data that is a virus, a hostile applet or a code fragment that perform unauthorized process on a computer or the physical computer network 2. This data may be used to steal passwords, delete information and damage the physical computer network 2. By specifying malicious data in the set of rules, data that does not fall in the category of malicious data is allowed to be transferred to the physical computer network 2. In addition, if data or a file being transferred from the external device 5 to the physical computer network 2 is infected by a virus, the guard computer 1 ensures that the file is cleaned before it is transmitted to the physical computer network 2. Hence, protection of the physical computer network 2 from the malicious data is ensured. It may also be noted that when the external device 5 is connected to the guard computer 1, only the data which is scanned or filtered based on the set of rules is permitted to enter the physical computer network 2.

Furthermore, the set of rules specify a data bandwidth at which the data is made available to the physical computer network 2. This data bandwidth depends on the external device 5 connected to the guard computer 1. By such an arrangement an efficient amount of bandwidth utilization for the external device connected to the guard computer is ensured. The set of rules in the guard computer 1 also specify the external device 5 that is authorized to make data available to the physical computer network. This ensures that only authorized devices that comply with the set of rules can be connected to the physical computer network 2 thereby enhancing the security of the physical computer network 2 and data only through the authorized device is made available to the physical computer network. In one example, external devices can be connected to the physical computer network if a password entered by a user of the external device is correct. In another example, the external devices which have an encryption key that is authorized for connection can only make data available to the physical computer network 2.

In addition, the set of rules also specify the network resources in the physical computer network 2, to which data is made available from the external device for processing. As an example, data may be sent to a printer in the physical computer network 2 for printing a report. Also, data which includes information about an object which for example, may be a patient in a hospital is sent to the information server in the physical computer network 2. By such an arrangement an automated data management and a cost effective solution for the utilization of network resources is achieved in the physical computer network 2.

The set of rules also specify the limit for usage of the network resources in the physical computer network 2. More particularly, the set of rules specify the duration of time for the use of a particular resource. Additionally, the set of rules can also specify the number of times a particular resource can be used in a given amount of time duration. This helps in identifying a denial-of-service attack, which is an attempt by attackers to prevent legitimate users of a service from using that service. This denial-of-service attack is capable of disabling the physical computer network 2. To prevent denial-of-service attack, any unused or unneeded network services can be disabled, which can limit the ability of an attacker to take advantage of those services to execute the denial-of-service attack.

In addition, the set of rules may also incorporate a local security policy meant for the physical computer network 2. Hence, the set of rules can also specify the behavior of the physical computer network 2 like raising an alarm if an unauthorized device is connected to the physical computer network 2, which could be due to an intruder trying to enter the physical computer network 2.

FIG. 2 shows a system 8 that includes a controller computer 10 connected to the guard computer 1. In accordance with aspects of the present invention, the controller computer 10 may be remotely located to the guard computer 1. The controller computer 10 is connected to the guard computer via the physical computer network 2. In one embodiment, the controller computer may be physically connected to the guard computer 1. In another embodiment, the controller computer 10 may be connected to the guard computer 1 through a wireless device.

The controller computer 10 is configured to remotely adapt the rules on the guard computer 1. As an example, the controller computer is configured to replace the configuration file in the guard computer 1. The controller computer 10 remotely replaces configuration file 7 via use of a file transfer protocol (ftp) in the physical computer network 2. The rules in the configuration file 7 are compared with a default set on the controller computer 10 to check for any differences, if there are differences between the set of rules in the configuration file and the default set of rules on the controller computer 10, the controller computer 10 sends a message regarding update of the set of rules in the guard computer 1. Alternatively, if the additional rules are to be added, the additional rules are transmitted to the guard computer via the physical computer network 2 and the configuration file 7 is updated. Such an arrangement enables remote management of the guard computer 1 based on the requirements for the physical computer network 2. In addition, the guard computer 1 can be instructed by the controller computer 10 to limit network usage by communicating to the guard computer 1 about a data bandwidth at which the data is made available to the physical computer network 2. The controller computer 10 is also able to allocate available network bandwidth for performing a task by the guard computer 1. As previously noted, the guard computer 1 is configured to perform various tasks, the guard computer 1 is configured to communicate to the controller computer 10 the kind of task and network usage, such that the controller computer 10 is able to allocate the available network bandwidth to the guard computer for performing the task.

In accordance with aspects of the present invention, the physical computer network 2 may include a plurality of guard computers, such as the guard computer 1, wherein the plurality of guard computers are assigned to perform individual tasks. The controller computer 10 updates the rules on the plurality of guard computers simultaneously to avoid any discrepancy between the plurality of guard computers with respect to the set of rules in the configuration file 7.

Also, one or more guard computers, such as the guard computer 1 may be connected to the physical computer network 2 as a cloud and may be configured for “cloud computing”. It may be noted that “cloud computing” is a type of computing that relies on sharing computing resources rather than having local servers or personal devices to handle applications. The goal of cloud computing is to apply traditional supercomputing power to perform large computations per second.

The guard computer 1 can be assigned arbitrary computation task for the physical computer network 2, depending on the available capacity of the guard computer 1. The cloud of guard computers, such as the guard computer 1 may be utilized to perform large computational task at the discretion of the controller computer 10.

Additionally, the controller computer 10 is configured to provide for load-balancing by distributing workload evenly across the plurality of guard computers, in order to get optimal resource utilization, maximize throughput, minimize response time and avoid overload. As an example, if one guard computer is scanning large amount of data from the external device 5, the controller computer 10 distributes the data scanning task to other guard computers connected to the physical computer network 2 and hence avoid overload.

Furthermore, the controller computer 10 also schedules operations to be performed by the guard computer 1 based on the priority of operations. By such an arrangement the operations which need to be performed urgently are performed earlier than the other operations. As an example, a system shutdown operation due to security threat will be performed earlier than a scheduled virus scan in the physical computer network. Additionally, the controller computer 10 is configured to maintain upgrades of software on the guard computer 1. The guard computer 1 may include different kinds of software, which are according to the set of rules for the physical computer network 2. These software have to be upgraded to enable them to perform the tasks efficiently. The controller computer 10 sends the required updates and upgraded versions of the software to the guard computer 1 so as to provide better compliance of rules for the physical computer network 2.

The guard computer 1 and the controller computer 10 have a two way communication, such that the guard computer 1 can communicate to the controller computer 10 about the non-compliance of the set of rules by the external device 5, for example.

FIG. 3 shows an exemplary embodiment of controller computer 10 of FIG. 2, wherein the controller computer includes a master computer 11 and a proxy computer 12. As used herein, the term “proxy computer” is used for an intermediate computer that acts on behalf of other computer such as the master computer 12 for purposes such as data storage and security. The proxy computer 11 may also be used as a logical and a physical barrier and also helps in preventing an attacker from invading a private network such as the physical computer network 2. The proxy computer 12 is connected to the physical computer network 2 and the master computer 11 is connected to the proxy computer 12 via an external network 13 such as a wide area network or an internet, for example. The external network 13 could be any network that does not form the part of the physical computer network 2. It may be noted that the proxy computer 12 may be connected to the physical computer network 2, directly or through the guard computer 1 (see FIG. 1) which in turn is connected to the physical computer network 2. In one embodiment, the proxy computer 12 may be configured to act as a guard computer, such as the guard computer 1 of FIG. 1. In this configuration the proxy computer 12 is directly connected to the physical computer network 2. The master computer 11 which is located at a distant location from the physical computer network 2 modifies the set of rules and communicates the set of rules to the proxy computer 12. The proxy computer 12 is instructed by the master computer 11 to change the configuration file 7 including the set of rules in the guard computer 1. Such an arrangement enables remote management of the physical computer network 2. In a non-limiting example, if the headquarters of an organization modifies the set of rules, the master computer 11 located in the headquarters would communicate to the proxy computer 12 about the modified set of rules, the proxy computer 12 in turn will ensure that those set of rules are also incorporated for a branch office which is the physical computer network 2 in the present context.

The exemplary guard computer 1 and the system 8 employing the guard computer 1 have several advantages. These include providing data from the external device 5 to the physical computer network 2 by acting as a mediator between the external device 5 and the physical computer network 2 without having to modify the external device 5 itself. In addition, the exemplary guard computer 1 and the system 8 prevents attack by viruses by providing timely updates of anti-virus software, fast detection of security incidents and their centralized fixing. Further, the guard computer also aids in collection of event logs which may be utilized to examine the types of threats to the physical computer network.

While the disclosure has been described with reference to various embodiments, those skilled in the art will appreciate that certain substitutions, alterations and omissions may be made to the embodiments without departing from the spirit of the disclosure. Accordingly, the foregoing description is meant to be exemplary only, and should not limit the scope of the disclosure as set forth in the following claims.

1. A guard computer for connecting an external device to a physical computer network, comprising:
a network interface for connecting to the physical computer network;
a device interface for connecting the external device having a data repository containing data;
a configuration file containing a set of rules for making the data available to the physical computer network; and
a processor for making the data available to the physical computer network based upon the set of rules.

2. The guard computer according to claim 1, wherein the set of rules specify malicious data.

3. The guard computer according to claim 1, wherein the set of rules specify a data bandwidth at which the data is made available to the physical computer network depending on the external device.

4. The guard computer according to claim 1, wherein the set of rules specify the external device authorized to make data available to the physical computer network.

5. The guard computer according to claim 1, wherein the set of rules specify network resources to which data is made available for processing.

6. The guard computer according to claim 1, wherein the set of rules specify a limit for usage of the network resources.

7. The guard computer according to claim 1, wherein the external device is a portable computer.

8. The guard computer according to claim 1, wherein the external device is a data storage device.

9. The guard computer according to claim 8, wherein the processor is configured to access data from the data storage device for making the data available to the physical computer network.

10. A guard computer for connecting an external computer to a physical computer network, comprising:
a network interface for connecting to the physical computer network;
a device interface for connecting the external computer having a data repository containing data;
a configuration file containing a set of rules for making the data available to the physical computer network; and
a processor for making data available to the physical computer network based upon the set of rules.

11. The guard computer according to claim 10, wherein the processor is configured to access the data in the data repository of the external computer to check for compliance of the data based upon the set of rules.

12. The guard computer according to claim 10, wherein the processor is further configured to check data transmitted from the external computer to the guard computer for compliance of the data based upon the set of rules before making data available to the physical computer network.

13. A system comprising a controller computer and a guard computer connected to the controller computer, wherein the guard computer comprises:
a network interface for connecting to the physical computer network;
a device interface for connecting the external device having a data repository containing data;
a configuration file containing a set of rules for making the data available to the physical computer network; and
a processor for making data available to the physical computer network based upon the set of rules.

14. The system according to claim 13, wherein the controller computer is configured to remotely adapt the rules on the guard computer.

15. The system according to claim 13, wherein the controller computer comprises a proxy computer connected to the physical computer network and a master computer connected to the proxy computer via an external network.

16. The system according to claim 15, wherein the master computer is configured to modify the set of rules and communicate a new set of rules to the proxy computer for changing the configuration file in the guard computer.

17. The system according to claim 13, wherein the controller computer is configured to schedule operations to be performed by the guard computer based on the priority of operations for the physical computer network.

18. The system according to claim 13, wherein the controller computer is further configured to maintain upgrades of application software on the guard computer.

19. The system according to claim 13, wherein the guard computer is configured to provide information about the non-compliance of the set of rules by the external device to the controller computer.

20. The system according to claim 13, wherein the controller computer is adapted to communicate to the guard computer about a data bandwidth at which the data is made available to the physical computer network.
